(19) United States
(12) Patent Application Publication
(10) Pub. No.: US 2006/0170687 A1
(43) Pub. Date: Aug. 3, 2006

(54) Electronic device and its operation explanation display method

(75) Inventors: Hiroyuki Nakamura, Tokyo (JP); Ken Miyashita, Tokyo (JP); Kouichi Matsuda, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/559,662

(22) PCT Filed: Jun. 16, 2004
(86) PCT No.: PCT/JP04/08782

§ 371 Date: Dec. 5, 2005

(30) Foreign Application Priority Data
Jun. 16, 2003 (JP) 2003-171360

(51) Int. Cl. G06T 15/70

(52) U.S. Cl. 345/473

(57) ABSTRACT

Disclosed is an electronic device/apparatus capable of displaying an animation that varies with internal settings and minimizing the amount of memory use for handling information for animation generation. When a shutter button (12) is pressed in a help display mode, flash ON/OFF setup information (52) stored in an EEPROM (25) is referenced. If the value of the flash ON/OFF setup information is ON, a three-dimensional animation in which a flash (104) on a three-dimensional model (71) emits light is created and displayed in accordance with three-dimensional model data. If, on the other hand, the value is OFF, a three-dimensional animation in which the flash (104) on the three-dimensional (71) model does not emit light is displayed. Consequently, the user can recognize visually and intuitively the difference among various digital camera (100) motions that vary with system settings.

### TECHNICAL FIELD

The present invention relates to an electronic device/apparatus capable of displaying animated operating instructions and a method for displaying such animated operating instructions.

### BACKGROUND ART

An instruction manual is attached to each electronic device. However, PDAs (Personal Digital Assistants or Personal Data Assistants), digital cameras, cellular phones, and other mobile electronic devices, which are frequently used outdoors, are provided with electronic operating instructions, which are stored in memory. The users of such mobile electronic devices do not have to carry the instruction manual because they can view the electronic operating instructions on a display screen.

However, the display screen resolution of a mobile electronic device is generally low. The number and size of characters that can be simultaneously displayed on screen are stringently limited. Therefore, it is difficult to supply an adequate amount of operating instructions to the user. Further, the user finds it difficult to understand the operating instructions that are given only in the form of text information.

The above problem can be eased by furnishing image information to explain about operating instructions. Even when the display environment is poor, the user can intuitively understand operating instructions as far as they are given in the form of image information instead of text information.

As operating instructions given in the form of image information, animated electronic device motions may be used (refer, for instance, to Japanese Patent Laid-open No. 2000-184475 (paragraph 0042) and Japanese Patent Laid-open No. Hei 10-200798 (paragraph 0029). For example, if an animation is used to illustrate an electronic device motion that occurs when the user presses an operating control button, it is extremely easy for the user to understand operating instructions.

Strictly speaking, however, electronic device/apparatus motions are not always determined only by the press of an operating control button. In the case of a digital camera, for instance, a flash emits light or does not emit light depending on whether the flash is turned ON or OFF. Conventional animated operating instructions, however, did not variously indicate electronic device/apparatus motions depending on electronic device/apparatus internal settings.

Conventionally, a number of motion picture data, which displayed various motions, were saved in a memory. Thus, appropriate motion picture data was read from the memory and played back to display electronic device/apparatus motions. Therefore, the overall size of the motion picture data was increased each time the number of displayable motions was increased. As a result, a considerable amount of memory, which was limited in size, was used by such motion picture data.

The present invention has been made in view of the above circumstances and provides an electronic device/apparatus and electronic device/apparatus operating instructions display method for displaying various animations depending on internal settings and preventing the information necessary for displaying animations from using a significant amount of memory.

### DISCLOSURE OF INVENTION

In accomplishing the above objects, according to one aspect of the present invention, there is provided an electronic device/apparatus comprising: an electronic device main body that is capable of moving in accordance with an operation; a setup information retention section for retaining setup information that is to be reflected in the motion of the electronic device main body; an operating control section for allowing the user to specify the motion to be performed by the electronic device main body; a display section having a display screen; and animation display means, which, when the operating control section specifies the motion of the electronic device main body, causes the display screen to display an animation for indicating the specified motion of the electronic device main body in which the setup information retained in the setup information retention section is reflected. Therefore, the present invention displays various animations depending on the setup of the electronic device/apparatus so that the user can recognize visually and intuitively the difference among various electronic device/apparatus motions, which vary with the setup.

The electronic device/apparatus according to the present invention may include a model data storage section for storing model data about the electronic device/apparatus. The animation display means may process model data stored in the model data storage section to create animations. In other words, the model data can be rendered in real time to create animations. Various animated motions can therefore be created from a single piece of model data. As a result, the amount of memory use can be minimized.

In the electronic device/apparatus according to the present invention, the animation display means may process the model data stored in the model data storage section and cause the display screen to display a second animation, which indicates an operating control that can recall an animation for indicating a motion of the electronic device main body. This feature enables the user to quickly find an operating control button for recalling an animation that indicates a motion of the electronic device main body. Further, the model data can be rendered in real time to create the second animation. Thus, the amount of memory use can be minimized.

The electronic device/apparatus according to the present invention may include means for manipulating the setup information in the setup information retention section. This feature makes it possible to display different animated motions by changing the setup of the electronic device/apparatus.

According to another aspect of the present invention, there is provided an operating instructions display method for an electronic device/apparatus that includes an electronic device main body capable of moving in accordance with an operation, a setup information retention section for retaining setup information that is to be reflected in a motion of the electronic device main body, an operating control section for allowing the user to specify the motion to be performed by the electronic device main body, and a display section having a display screen, the operating instructions display method comprising the step of creating, when the operating control section specifies the motion to be performed by the electronic device main body, an animation indicating the specified motion of the electronic device main body in which the setup information retained in the setup information retention section is reflected, and causing the display screen to display the created animation. The present invention displays various animations depending on the setup of the electronic device/apparatus so that the user can recognize visually and intuitively the difference among various electronic device/apparatus motions, which vary with the setup.

The electronic device/apparatus operating instructions display method according to the present invention may process stored model data about an electronic device/apparatus to create animations. In other words, the model data can be rendered in real time to create animations. Various animated motions can therefore be created from a single piece of model data. As a result, the amount of memory use can be minimized.

Further, the electronic device/apparatus operating instructions display method according to the present invention may process the stored model data and cause the display screen to display a second animation, which indicates an operating control that can recall an animation for indicating a motion of the electronic device main body. This feature enables the user to quickly find an operating control button for recalling an animation that indicates a motion of the electronic device main body. Moreover, the model data can be rendered in real time to create the second animation. Thus, the amount of memory use can be minimized.

### BRIEF DESCRIPTION OF DRAWINGS

FIG. 1 is a front perspective view of a digital camera according to one embodiment of the present invention;

FIG. 2 is a rear perspective view of the digital camera shown in FIG. 1;

FIG. 3 is a block diagram illustrating the electrical configuration of the digital camera shown in FIG. 1;

FIG. 4 shows a part of a ROM memory map;

FIG. 5 shows a part of an EEPROM memory map;

FIG. 6 is a flowchart illustrating a three-dimensional animation display process that is performed to furnish operating instructions for the digital camera shown in FIG. 1;

FIG. 7 shows a typical three-dimensional animation for indicating to the user an operating control button that can recall a three-dimensional animation for furnishing operating instructions;

FIG. 8 shows a rotated view of the three-dimensional animation in FIG. 7;

FIG. 9 is a flowchart illustrating a flash ON/OFF setup procedure;

FIG. 10 is a flowchart illustrating a process for displaying a three-dimensional animation in which a system setup is reflected;

FIG. 11 shows a typical animation in which a flash on a three-dimensional model emits light;

FIG. 12 is a flowchart illustrating a three-dimensional animation display process for indicating a digital camera motion that is performed when a zoom button is pressed;

FIG. 13 illustrates a state prevailing before the lens section of a three-dimensional model is extended;

FIG. 14 illustrates a state prevailing when the lens section of a three-dimensional model is extended;

FIG. 15 illustrates a state prevailing before an image displayed on the LCD monitor screen of a three-dimensional model is enlarged; and

FIG. 16 illustrates a state prevailing when an image displayed on the LCD monitor screen of a three-dimensional model is enlarged.

### BEST MODE FOR CARRYING OUT THE INVENTION

An embodiment of the present invention will now be described with reference to the accompanying drawings. In the present embodiment, an electronic device/apparatus according to the present invention is applied to a digital camera.

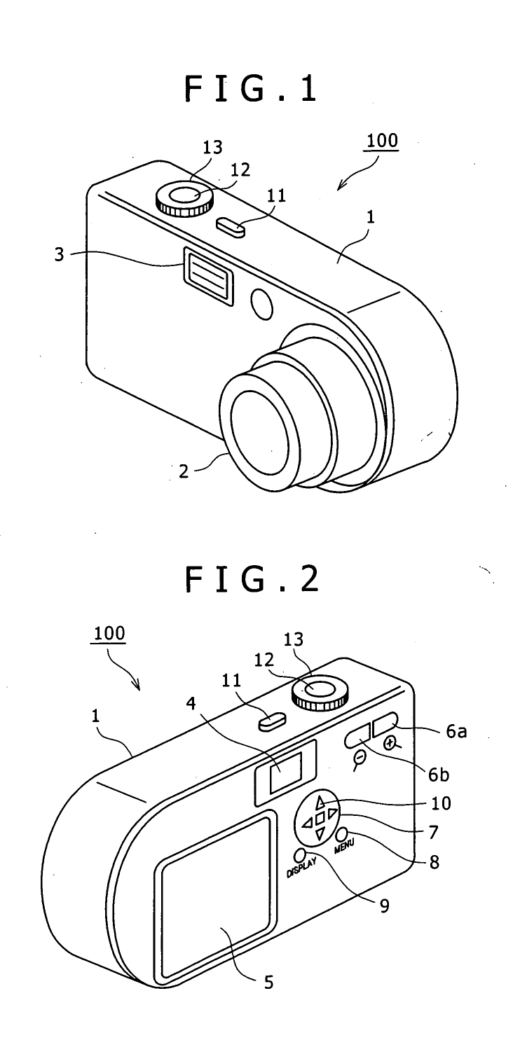

FIG. 1 is a front perspective view of the digital camera 100. FIG. 2 is a rear perspective view of the digital camera 100. In these figures, the reference numeral 1 denotes a housing for the digital camera 100. The housing 1 includes, for instance, a zoom type lens section 2, a built-in flash 3, an optical viewfinder 4, an LCD monitor 5, zoom buttons 6a, 6b, a macro shot button 7, a menu display button 8, a display change button 9, a flash disable button 10, a power button 11, a shutter button 12, and a mode dial 13.

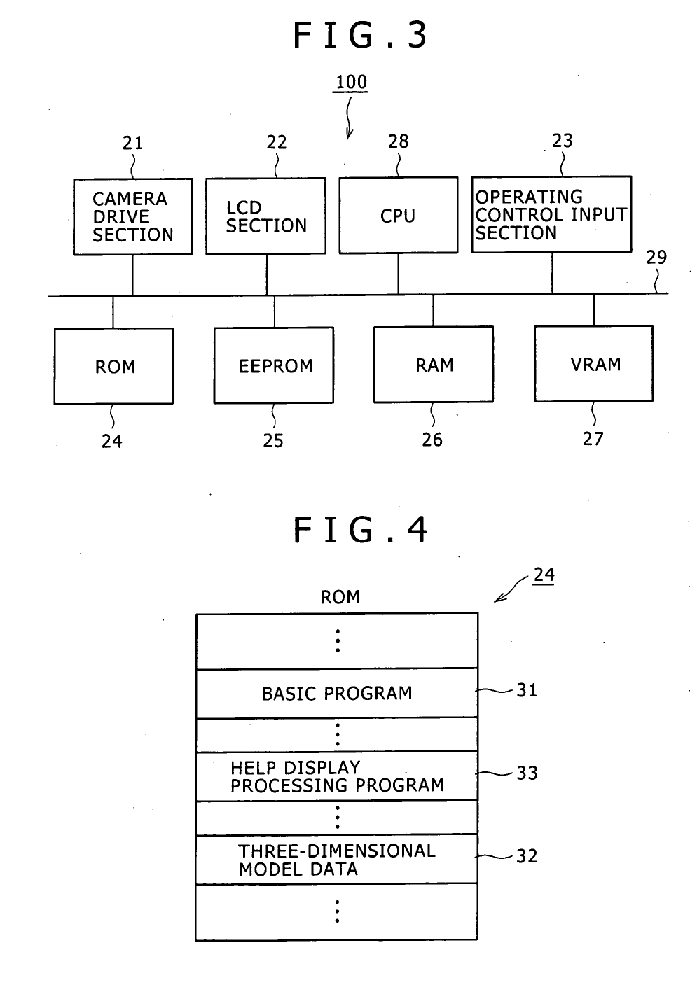

FIG. 3 is a block diagram illustrating the electrical configuration of the digital camera 100. As shown in FIG. 3, the digital camera 100 includes, for instance, a camera drive section 21, an LCD section 22, an operating control input section 23, a ROM (Read Only Memory) 24, an EEPROM (Electrically Erasable Programmable Read Only Memory) 25, a RAM (Random Access Memory) 26, a VRAM (Video Random Access Memory) 27, a CPU (Central Processing Unit) 28, and a bus 29.

The camera drive section 21 is an element for driving various mechanisms within the digital camera 100. It includes, for instance, a solid-state image sensing device for converting a light input via the lens section 2 into an electrical signal; a signal processing circuit for processing the electrical signal, which is obtained in the solid-state image sensing device, to generate digital image data; a drive circuit for driving a zoom mechanism for the lens section 2; and a drive circuit for driving the built-in flash 3.

The LCD section 22 is an element for performing a process for displaying an image on the LCD monitor 5. The LCD section 22 includes, for instance, the LCD monitor 5 and a video processing circuit for generating a signal for displaying an image on the LCD monitor 5 from digital image data retained in the VRAM 27.

The operating control input section 23 is an element for monitoring the operating states, for instance, of the zoom buttons 6a, 6b, macro shot button 7, menu display button 8, display change button 9, flash disable button 10, power button 11, shutter button 12, and mode dial 13, and entering the results of monitoring into the CPU 28 via the bus 29.

The ROM 24 is a read-only memory for storing, for instance, data and various programs that the CPU 28 executes to operate the digital camera 100. FIG. 4 shows a part of a memory map of the ROM. As indicated in the memory map, the ROM 24 stores a basic program 31 for operating the digital camera 100, three-dimensional model data 32 for the digital camera, and a help display processing program 33 that includes a processing procedure for rendering the three-dimensional model data 32 and creating a three-dimensional animation to explain about the operating instructions for the digital camera 100.

A process for rendering the three-dimensional model data will now be described. The three-dimensional model data, which comprises the data about the three-dimensional coordinate locations of polygons (polygonal planes), points, lines, planes, and other graphical elements, the attributes of lines and planes, and colors, is read from the ROM 24. The three-dimensional coordinates of all three-dimensional model regions are converted to two-dimensional coordinates. Next, a hidden-surface removal process is performed on the obtained two-dimensional coordinates. In the hidden-surface removal process, the graphical elements are sorted in order from the farthest to the nearest so that only visible regions eventually remain. A rasterization process is then performed on the data that has been subjected to the hidden-surface removal process so that individual pixel color numbers are written in a color buffer. In accordance with the individual pixel color numbers stored in the color buffer, the associated RGB values are recalled from a color table that stores the relationships between RGB values and color numbers. The RGB values are then converted to video signals that can be handled by a display device. The resulting video signals are output to the LCD monitor 5.

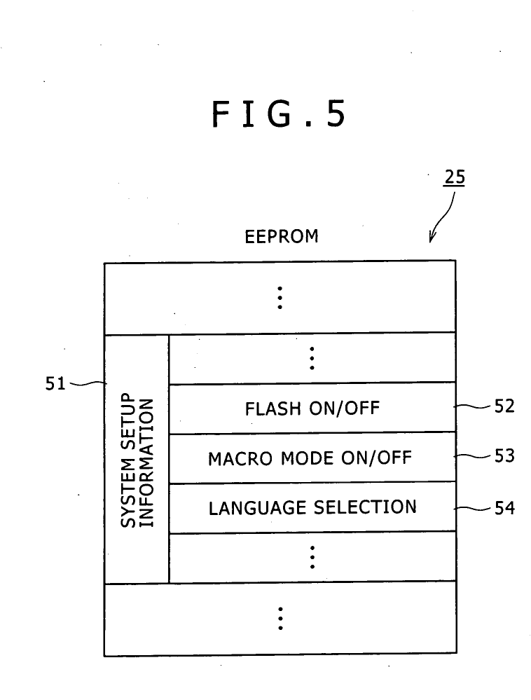

The EEPROM 25 is a nonvolatile memory for storing system setup information, which indicates the settings of the digital camera 100. FIG. 5 shows a part of a memory map of the EEPROM 25. As indicated in FIG. 5, the system setup information 51 stored in the EEPROM 25 includes, for instance, flash ON/OFF setup information 52, macro mode ON/OFF setup information 53, and language selection setup information 54.

The RAM 26 can be freely read and written into. It is used, for instance, as a temporary storage area for three-dimensional model data rendering.

The VRAM 27 is a memory for storing digital image data that is to be displayed on the LCD monitor 5.

The operation that the digital camera 100 performs to display a three-dimensional animation for explaining about operating instructions will now be described.

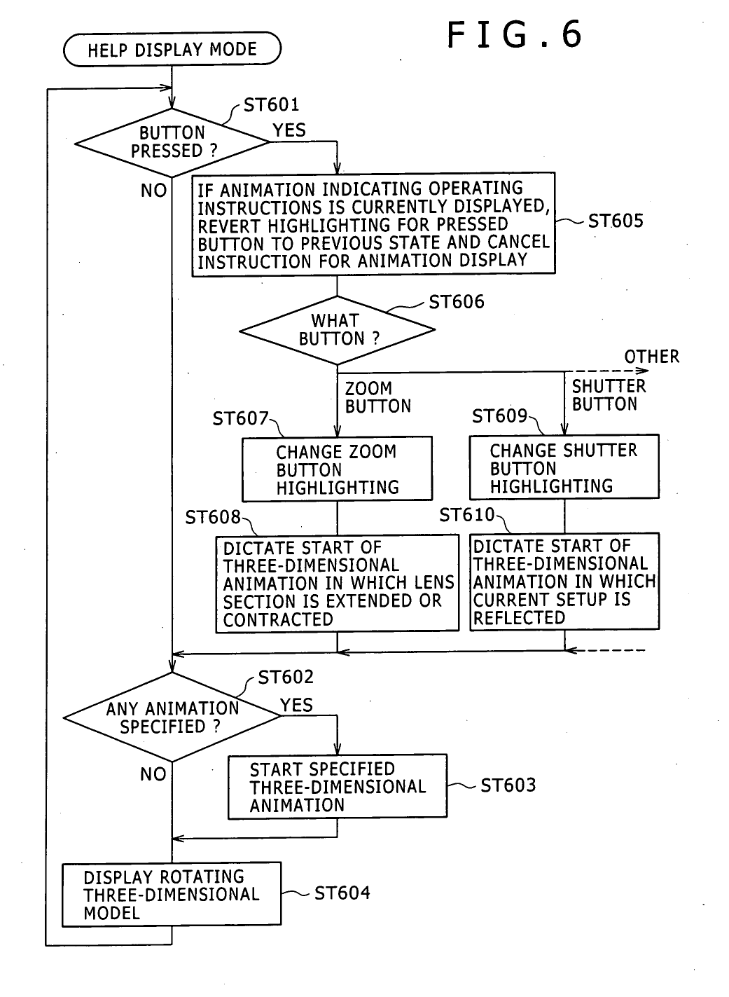

FIG. 6 is a flowchart that summarizes the operation.

When using Help, the user performs a procedure for changing the mode of the digital camera 100 from a normal mode for shooting to a help display mode. For example, when the zoom buttons 6a, 6b and display change button 9, which are shown in FIG. 2, are simultaneously pressed, the basic program 31 detects the simultaneous button press and launches the help display processing program 33. The help display processing program 33 then starts up to select the help display mode. When the user presses an operating control button on the digital camera 100 in the help display mode, the associated input signal is processed by the help display processing program 33.

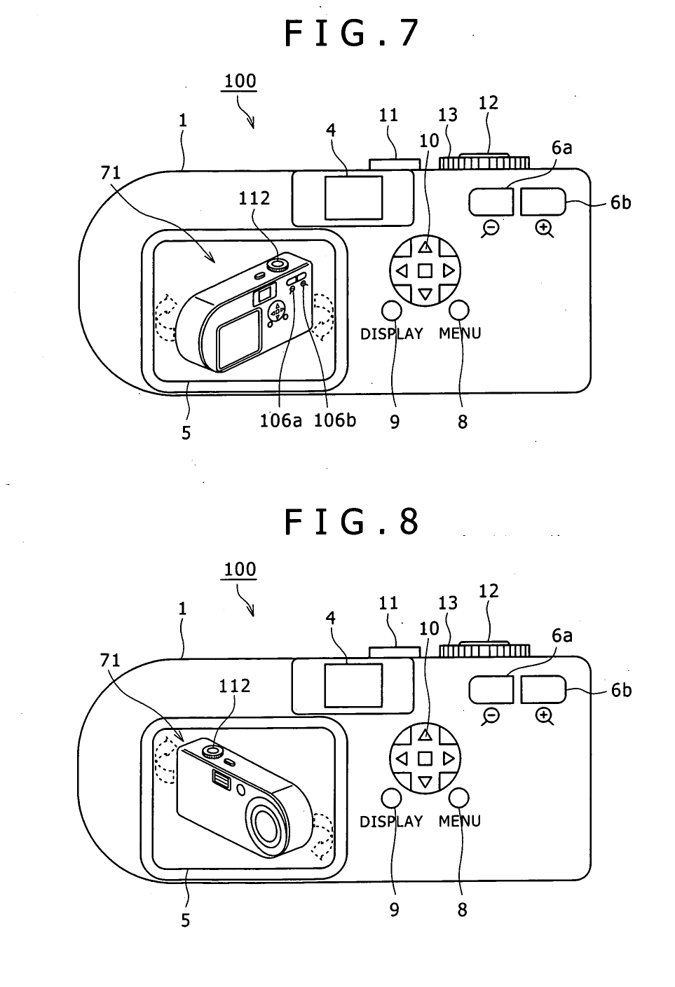

The help display processing program 33 first reads the digital camera's three-dimensional model data 32 from the ROM 24, performs rendering, and creates a three-dimensional animation for indicating to the user an operating control button for recalling a three-dimensional animation for explaining about operating instructions. FIGS. 7 and 8 show such a three-dimensional animation. This three-dimensional animation rotates a digital camera's three-dimensional model 71 on the spot (NO to the query in step ST601->NO to the query in step ST602->step ST604).

In the rotating three-dimensional model 71 of the digital camera, the operating control button for recalling a three-dimensional animation for furnishing operating instructions blinks, becomes conspicuously colored, or otherwise becomes highlighted so that it can be distinguished from the other operating control buttons that cannot recall a three-dimensional animation. In the example shown in FIGS. 7 and 8, the shutter button 112 and zoom buttons 106a, 106b in the displayed rotating three-dimensional model 71 are highlighted.

When the user presses a real operating control button (shutter button 12, zoom button 6a, or zoom button 6b) that corresponds to one of the highlighted operating control buttons (shutter button 112, zoom button 106a, or zoom button 106b on the three-dimensional model 71) (when the query in step ST601 is answered “YES”), the operating control input section 23 detects such a button press. A detection signal concerning the pressed button is then input into the CPU 28 via the bus 29 on an interrupt basis.

In accordance with such an interrupt signal input into the CPU 28, the help display processing program 33 recognizes the button press and the type of the pressed button, creates a three-dimensional animation for indicating the motion that the digital camera 100 performs at the press of the recognized button while considering the system setup information 51, and displays the created three-dimensional animation. This process will be described in detail later.

The system setup information will now be described. As shown in FIG. 5, the system setup information 51 includes, for instance, the flash ON/OFF setup information, macro mode ON/OFF setup information 53, and language selection setup information 54.

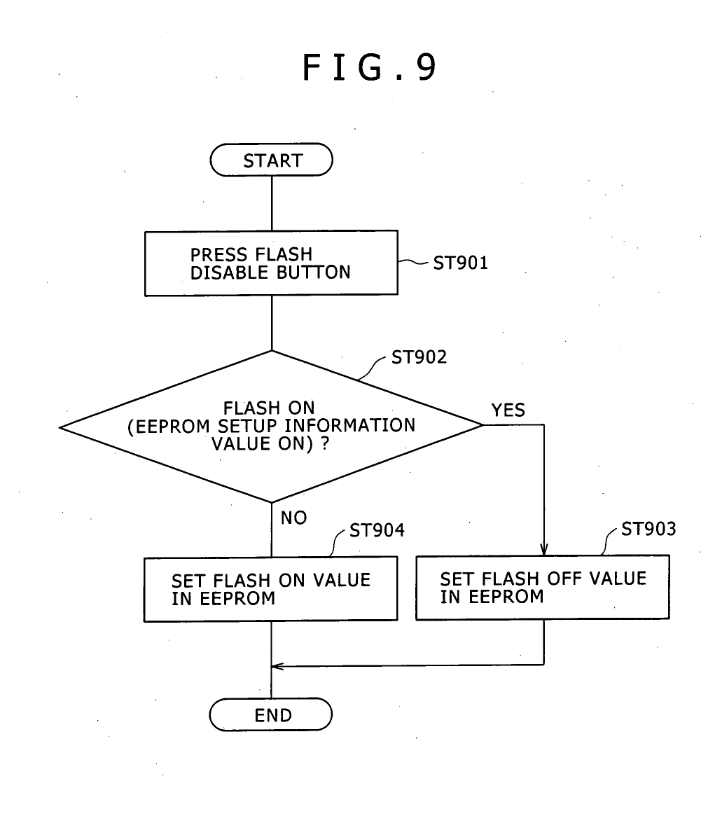

Flash ON/OFF setup is performed in accordance with the status of the flash disable button 10. FIG. 9 illustrates a flash ON/OFF setup procedure. When the flash disable button is pressed (step ST901), the basic program checks the flash ON/OFF setup information 52 that is already retained in the EEPROM 25. If the retained flash ON/OFF setup information value is ON (if the query in step ST902 is answered “YES”), the flash is turned OFF (to disable the flash) (step ST903). If, on the other hand, the retained flash ON/OFF setup information value is OFF (if the query in step ST902 is answered “NO”), the flash is turned ON (step ST904). The user can open a setup confirmation screen on the LCD monitor 5 to confirm the flash ON/OFF setup information 52. The setup confirmation screen can be opened by selecting an option from a menu screen, which opens when the menu display button 8 is pressed.

Macro mode ON/OFF setup is performed in the same manner as for flash ON/OFF setup except that the macro shot button 7 is used. The user can confirm the macro mode ON/OFF setup information 53 from the setup confirmation screen that appears on the LCD monitor 5. Language selection setup is performed to change the on-screen display language from Japanese to English or vice versa. A language selection can be made, for instance, by touching a language selection screen that appears on the LCD monitor 5. A touch sensor panel is attached to the screen for the LCD monitor 5. The touch sensor panel detects the coordinates of an on-screen point that the user touches with a finger, pen, or the like. The type of the language associated with the detected coordinates is then set as the language selection setup information 54.

The operation performed when the shutter button 12, zoom button 6a, or zoom button 6b is pressed in the help display mode will now be described.

Returning to the flowchart in FIG. 6, when the help display processing program 33 recognizes in step ST606 that the shutter button 12 is pressed by the user, the shutter button 112 on the digital camera's rotating three-dimensional model 71, which is displayed in FIGS. 7 and 8, changes its highlighting (blinking, color, etc.) (step ST609). This permits the user to intuitively recognize that the press of the shutter button 12 is accepted.

Next, the help display processing program 33 sets a flag for dictating the start of a three-dimensional animation in which the current system setup is reflected (step ST610). When this flag is set, the help display processing program 33 performs a process for displaying a three-dimensional animation in which the system setup is reflected.

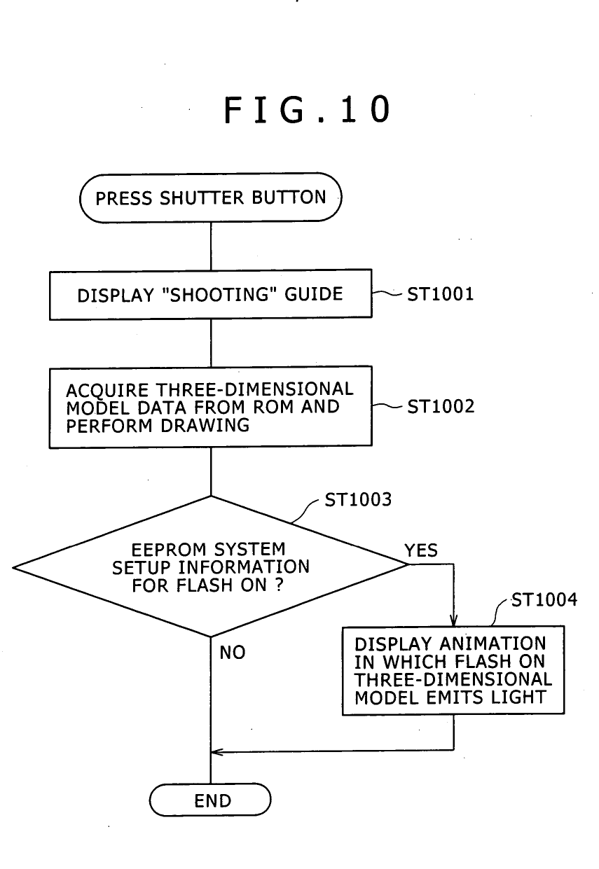

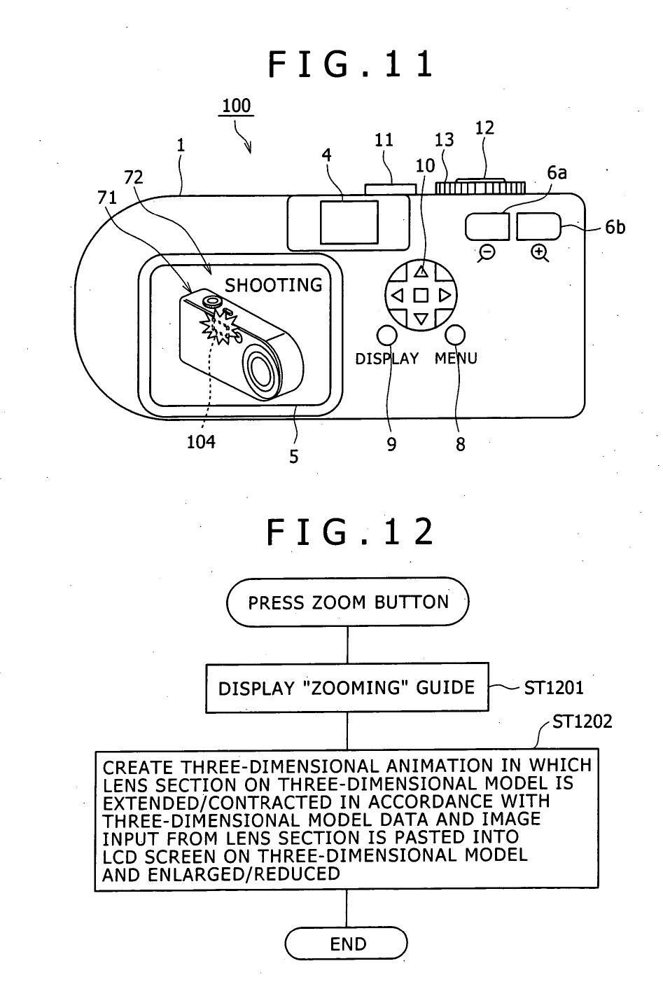

FIG. 10 is a flowchart illustrating a process that is performed to display a three-dimensional animation in which the system setup is reflected. First of all, the help display processing program 33 displays a guide 72, which is a message (e.g., “Shooting” as shown in FIG. 11) indicating the motion of the digital camera 100 that is performed at the press of the shutter button 12 (step ST1001). Next, the help display processing program 33 acquires the digital camera's three-dimensional model data 32 from the ROM 24 and performs rendering (step ST1002).

The help display processing program 33 then reads the system setup information 51 that is already retained in the EEPROM 25. It is predetermined that the system setup information 51 affecting the motion of the digital camera 100 at the press of the shutter button 12 is the flash ON/OFF setup information 52. Therefore, the help display processing program 33 references the flash ON/OFF setup information 52 retained in the EEPROM 25 (step ST1003). If the value of the flash ON/OFF setup information 52 is ON (if the query in step ST1003 is answered “YES”), an animation appears on the display so that the flash 104 on the three-dimensional model 71 emits light as shown in FIG. 11 (step ST1004). If, on the other hand, the value of the flash ON/OFF setup information 52 is OFF (if the query in step ST1003 is answered “NO”), the guide 72, which is a message indicating the motion of the digital camera 100 that is performed at the press of the shutter button 12, appears on the display, and an animation in which the flash 104 on the three-dimensional model 71 does not emit light appears on the display.

If the flash is ON when the shutter button 12 is pressed, a written guide 72 and an animation of the three-dimensional model 71 appear on the display to furnish operating instructions to the user, thereby indicating that shooting is to be performed with the flash 104 emitting light, which is the motion performed by the digital camera 100 at the press of the shutter button 12. If, on the other hand, the flash is OFF when the shutter button is pressed, a written guide 72 and an animation of the three-dimensional model 71 appear on the display to furnish operating instructions to the user, thereby indicating that shooting is to be performed with the flash 104 emitting no light. When the three-dimensional animation is displayed at the press of the shutter button 12, the displayed three-dimensional model 71 may rotate in the same manner as the three-dimensional animation that indicates to the user an operating control button for recalling the three-dimensional animation for explaining about operating instructions or may stay still.

Returning to the flowchart in FIG. 6, when the help display processing program 33 recognizes in step ST606 that zoom button 6a or 6b (zoom in button 6a or zoom out button 6b) is pressed by the user, the zoom button 106a, 106b on the digital camera's rotating three-dimensional model 71, which is displayed in FIG. 7, changes its highlighting (blinking, color, etc.) (step ST607). This permits the user to intuitively recognize that the press of zoom button 6a or 6b is accepted. Next, the help display processing program 33 sets a flag for dictating the start of a three-dimensional animation in which the lens section 2 is extended or contracted (step ST608). When this flag is set, the help display processing program 33 extends or contracts the lens section 2 and performs a process for displaying a three-dimensional animation in which an image acquired through the lens section 2 is pasted into the screen of the LCD monitor 105 on the three-dimensional model 71.

FIG. 12 is a flowchart illustrating a three-dimensional animation display process for indicating the motion that the digital camera 100 performs at the press of zoom button 6a or 6b.

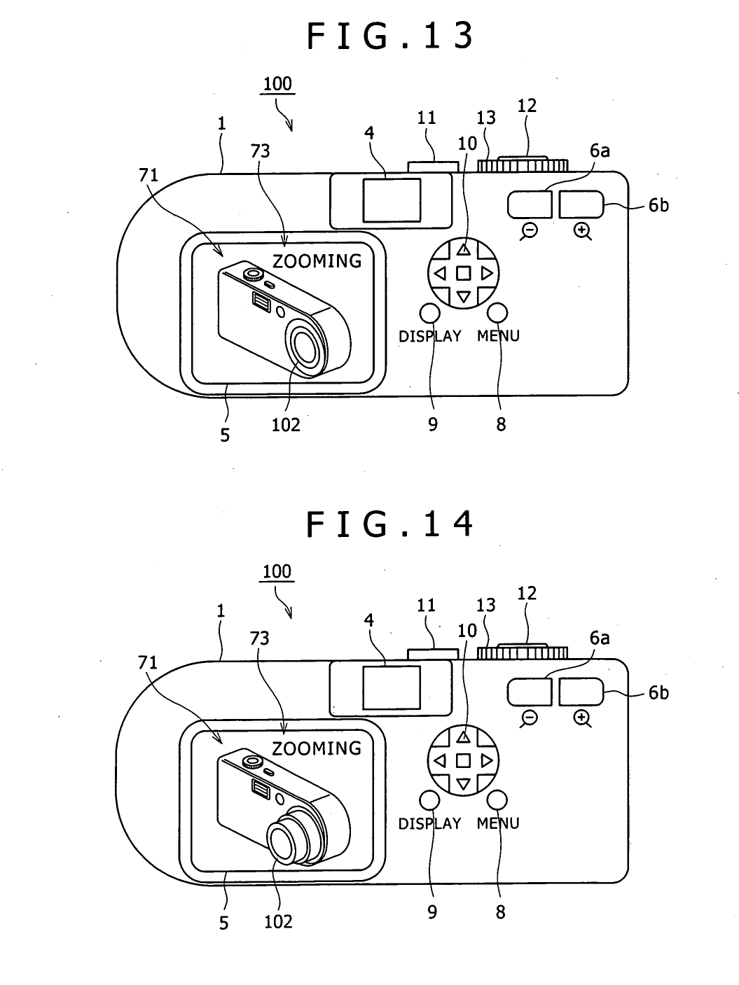

First of all, the help display processing program 33 displays a guide 73, which is a message (e.g., “Zooming” as shown in FIG. 13) indicating the motion of the digital camera 100 that is performed at the press of zoom button 6a or 6b (step ST1201). Next, the help display processing program 33 acquires the digital camera's three-dimensional model data 32 from the ROM 24 and creates a three-dimensional animation by using the three-dimensional model data 32 and the image data acquired through the lens section 2 (step ST 1202). In the created three-dimensional animation, the lens section 102 on the three-dimensional model 71 is extended or contracted, and the image data 74 input through the lens section 2 is pasted into the screen of the LCD monitor 105 on the three-dimensional model 71 and extended or contracted in coordination with the extension/contraction of the lens section 102 on the three-dimensional model 71. The image data 74 acquired through the lens section 2 is image data that is obtained when a light input from the lens section 2 is converted to an electrical signal by the solid-state image sensing device and then processed by the signal processing circuit.

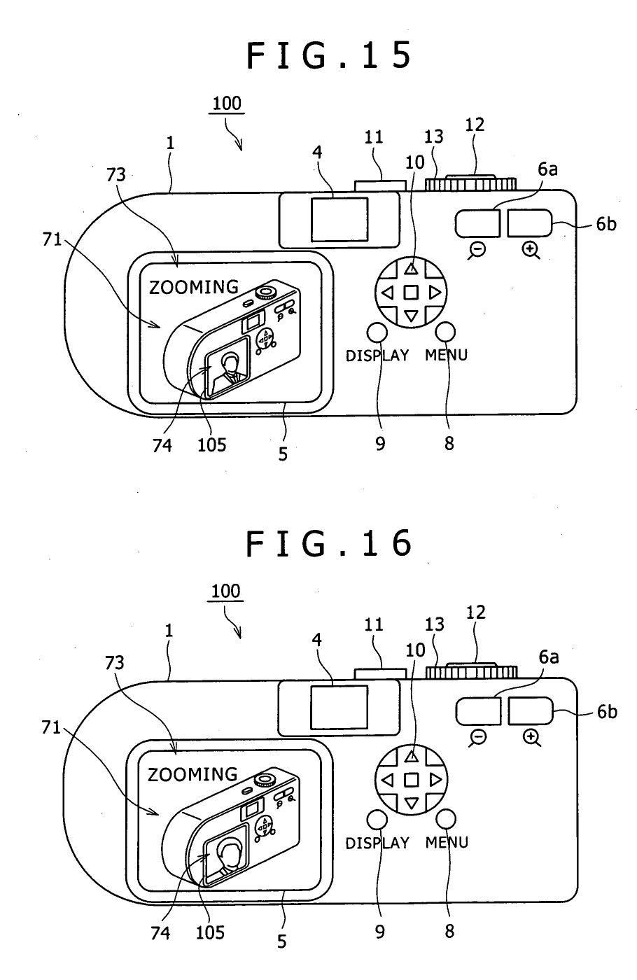

More specifically, the extension/contraction of the lens section 102 and the enlargement/reduction of the image data 74 are individually expressed on different time bases. In the case of zooming in, the rotation of the three-dimensional model 71 is temporarily stopped and the lens section 102 on the three-dimensional model 71 is gradually extended. When the lens section 102 is fully extended, the three-dimensional model 71 resumes rotating. When the plane containing the LCD monitor 105 is displayed at a predetermined angle, the image data 74 within the screen of the LCD monitor 105 on the three-dimensional model 71 is gradually enlarged as shown in FIGS. 15 and 16.

In the above example, the extension/contraction of the lens section 102 and the enlargement/reduction of the image data 74 are separately expressed on different time bases. Alternatively, however, an animation may be displayed so that the extension/contraction of the lens section 102 is in synchronism with the enlargement/reduction of the image data 74 while the three-dimensional model 71 is rotated.

Returning to the flowchart in FIG. 6, when the user presses an operating control button for recalling a new three-dimensional animation while a three-dimensional animation is being displayed to furnish operating instructions for the digital camera 100, the help display processing program 33 returns the highlighting of an operating control button on the displayed three-dimensional model for recalling a three-dimensional animation to the previous state, and resets the flag for dictating the display of the three-dimensional animation (step ST605). The displayed three-dimensional animation for furnishing operating instructions then stops, and the highlighting of the newly pressed operating control button changes. Further, a three-dimensional animation appears on the display to indicate the motion that the digital camera 100 performs at the press of the operating control button.

The foregoing embodiment description deals with a three-dimensional animation in which the flash ON/OFF setup information is reflected. However, the present invention is not limited to such a case. Various other items of setup information may be similarly reflected in the three-dimensional animation as far as they vary the visible motion of the digital camera 100.

Further, the foregoing embodiment description deals with a case where an animation indicating the extension/contraction of the lens section 102 and the enlargement/reduction of the image data 74 is displayed at the press of zoom button 6a or 6b. However, even when any other operation is performed, the image data 74 acquired through the lens section 2 may be pasted into the screen of the LCD monitor 105 on the three-dimensional model 71 and displayed. When, for instance, a three-dimensional animation is displayed to furnish operating instructions for the shutter button 12, the image data acquired through the lens section 2 may be pasted into the screen of the LCD monitor 105 on the three-dimensional model 71 and displayed.

Advantages provided by the present embodiment will now be described.

A three-dimensional animation for indicating (highlighting) an operating control button for recalling a three-dimensional animation to explain about operating instructions is displayed first. This feature enables the user to quickly find an operating control button for recalling a three-dimensional animation that furnishes operating instructions. This provides increased ease of operation.

When an operating control button on the digital camera 100 is pressed, a three-dimensional animation appears on the display to indicate the motion that the digital camera 100 performs at the press of the operating control button. Therefore, the user can readily recognize the relationship between operating control buttons and the motions of the digital camera 100.

The flash ON/OFF setup information and various other items of system setup information can be reflected in a three-dimensional animation for furnishing operating instructions. Therefore, the user can recognize visually and intuitively the difference among various motions of the digital camera 100 that vary with the system setup.

Three-dimensional animations for furnishing various operating instructions can be created from a single piece of three-dimensional data about a digital camera. The amount of memory use can be considerably reduced when compared with a method for storing various motion picture data for various operating instructions in a memory, reading target motion picture data from the memory, and playing back the read motion picture data.

The image data 74 acquired through the lens section 2 is pasted into the screen of the LCD monitor 105 on the three-dimensional model 71 and displayed. Therefore, it is possible to generate a three-dimensional animation for furnishing operating instructions in such a manner that the user can readily understand the operating instructions. Further, the image data pasted into the screen of the LCD monitor 105 is enlarged or reduced in coordination with an extension/contraction operation that is performed by the lens section 102 to exercise its zoom-in/zoom-out function. Therefore, this feature ensures that the user can readily understand the zoom-in/zoom-out effect.

The foregoing description assumes that the present invention is applied to a digital camera. However, the present invention can also be applied to various other electronic devices/apparatuses as far as they have a display section and a function for permitting the user to view on-screen operating instructions displayed on the display section. More specifically, the present invention is also applicable, for instance, to PDAs, cellular phones, and television sets. The animation is not limited to a three-dimensional type. The use of a two-dimensional animation is also acceptable.

As described above, the present invention displays animated motions that vary with the electronic device/apparatus setup. Therefore, the user can recognize visually and intuitively the difference among various motions of an electronic device/apparatus that vary with the setup.

1. An electronic device/apparatus comprising:
an electronic device main body that is capable of behaving in accordance with an operation;
a setup information retention section for retaining setup information that is to be reflected in a behavior of the electronic device main body;
an operating control section for allowing the user to specify the behavior to be performed by the electronic device main body;
a display section having a display screen;
a model data storage section for storing model data about the electronic device main body;
an image acquisition section for acquiring an image outside the electronic device main body; and
animation display means, which, when the operating control section specifies the behavior to be performed by the electronic device main body, causes the display screen to display an animation for indicating the specified behavior of the electronic device main body in which the setup information retained in the setup information retention section is reflected, wherein the animation display means creates the animation by performing a process for sticking image data acquired from the image acquisition section on an associated location in the display section within the model data stored in the model data storage section.

2. (canceled)

3. The electronic device/apparatus according to claim 1, wherein the animation display means processes the model data stored in the model data storage section and causes the display screen to display a second animation, which indicates an operating control that can recall an animation for indicating a behavior of the electronic device main body.

4. The electronic device/apparatus according to claim 1, further comprising means for manipulating the setup information in the setup information retention section.

5. An electronic device/apparatus operating instructions display method for an electronic device/apparatus that includes an electronic device main body capable of behaving in accordance with an operation; a setup information retention section for retaining setup information that is to be reflected in a behavior of the electronic device main body; an operating control section for allowing the user to specify the behavior to be performed by the electronic device main body; a display section having a display screen; a model data storage section for storing model data about the electronic device main body; and an image acquisition section for acquiring an image outside the electronic device main body, the operating instructions display method comprising the steps of:
creating, when the operating control section specifies the behavior to be performed by the electronic device main body, an animation indicating the specified behavior of the electronic device main body in which the setup information retained in the setup information retention section is reflected, and causing the display screen to display the created animation; and
creating the animation by performing a process for pasting image data acquired from the image acquisition section into an associated location in the display section within the model data stored in the model data storage section.

6. (canceled)

7. The electronic device/apparatus operating instructions display method according to claim 5, wherein the stored model data is processed to cause the display screen to display a second animation, which indicates an operating control that can recall an animation for indicating a behavior of the electronic device main body.

8. The electronic device/apparatus according to claim 1, wherein, when the image acquired by the image acquisition section changes, the animation display means performs a process for changing the pasted image data accordingly.
